(19) United States
(12) Patent Application Publication
(10) Pub. No.: US 2009/0097030 A1
(43) Pub. Date: Apr. 16, 2009

(54) SYSTEM AND METHOD FOR CHECKING FILTER SEGMENT ARRANGEMENT OF A COLOR FILTER IN A COLOR WHEEL

(75) Inventors: YU-LUN HO, Tu-Cheng (TW); PO-YUAN LAI, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/019,895

(22) Filed: Jan. 25, 2008

(30) Foreign Application Priority Data
Oct. 16, 2007 (CN) 200710202073.9

(51) Int. Cl. G01N 21/25

(52) U.S. Cl. 356/418

(57) ABSTRACT

A system for checking filter segment arrangement of a color filter includes a light source, an image capturing device, a processor, and an output device. The light source is disposed at a first side of a color filter for emitting light beams to illuminate the color filter. The image capturing device is disposed at a second side of the color filter opposite to the light source for capturing an image of the color filter illuminated by the light source. The processor is used for processing the image of the color filter captured by the image capturing device, detecting a filter segment arrangement of the color filter and judging whether the filter segment arrangement of the color filter is identical to a predetermined standard filter segment arrangement. The output device is used for outputting the result as judged by the processor.

### TECHNICAL FIELD

The present invention relates to color wheels for projectors and, particularly, to a system and a method for checking filter segment arrangement of a color filter in a color wheel.

### DESCRIPTION OF RELATED ART

Hitherto, a Digital Light Processing (DLP) projector has been known which includes a light-source unit having a light source, a color wheel for separating light beams emitted from the light source into three colors, a digital micromirror device (DMD) for forming an optical image according to image information by using the light beams transmitted by the color wheel, a projection lens for enlarging and projecting the optical image, and an outer casing for housing these components. Such projectors are widely used for multimedia presentations at conferences, academic meetings, exhibitions, and the like.

The color wheel is used for separating light beams into a plurality of colors by a color filter with a plurality of filter segments. There are many different types of color filters, which have different amounts of filter segments, such as three, four and so on. The arrangement of the filter segments should match the arrangement required by the DMD. Otherwise, the color of images projected by the projector would be disordered. So, it is essential to check the arrangement of the filter segments in the color filter manufacturing process.

Generally, color filter checking is performed by an operator by visual examination. This takes a lot of time and money, and can seriously affect the accuracy and efficiency of the checking, especially when a great number of color filters need to be checked.

What is needed, therefore, is a system and method that can automatically check color filters.

### SUMMARY

In accordance with one present embodiment, a system for checking filter segment arrangement of a color filter includes a light source, an image capturing device, a processor, and an output device. The light source is disposed at a first side of a color filter for emitting light beams to illuminate the color filter. The image capturing device is disposed at a second side of the color filter opposite to the light source for capturing an image of the color filter illuminated by the light source. The processor is used for processing the image of the color filter captured by the image capturing device, detecting a filter segment arrangement of the color filter and judging whether the filter segment arrangement of the color filter is identical to a predetermined standard filter segment arrangement. The output device is used for outputting the result as judged by the processor.

### BRIEF DESCRIPTION OF THE DRAWING

Many aspects of the present system and method for checking filter segment arrangement of a color filter can be better understood with reference to the following drawings. The components in the drawing are not necessarily drawn to scale, the emphasis instead being placed upon clearly illustrating the principles of the present system and method. Moreover, in the drawings, like reference numerals designate corresponding parts throughout the several views.

FIG. 1 is a schematic diagram illustrating a hardware configuration of a system for checking filter segment arrangement of a color filter in accordance with a present embodiment of the present invention.

FIG. 2 is a schematic view of a color filter with three filter segments.

FIG. 3 is a flow chart of a method for checking filter segment arrangement of a color filter in accordance with a present embodiment of the present invention.

### DETAILED DESCRIPTION OF THE EMBODIMENTS

Embodiments will now be described in detail below, with reference to the drawings.

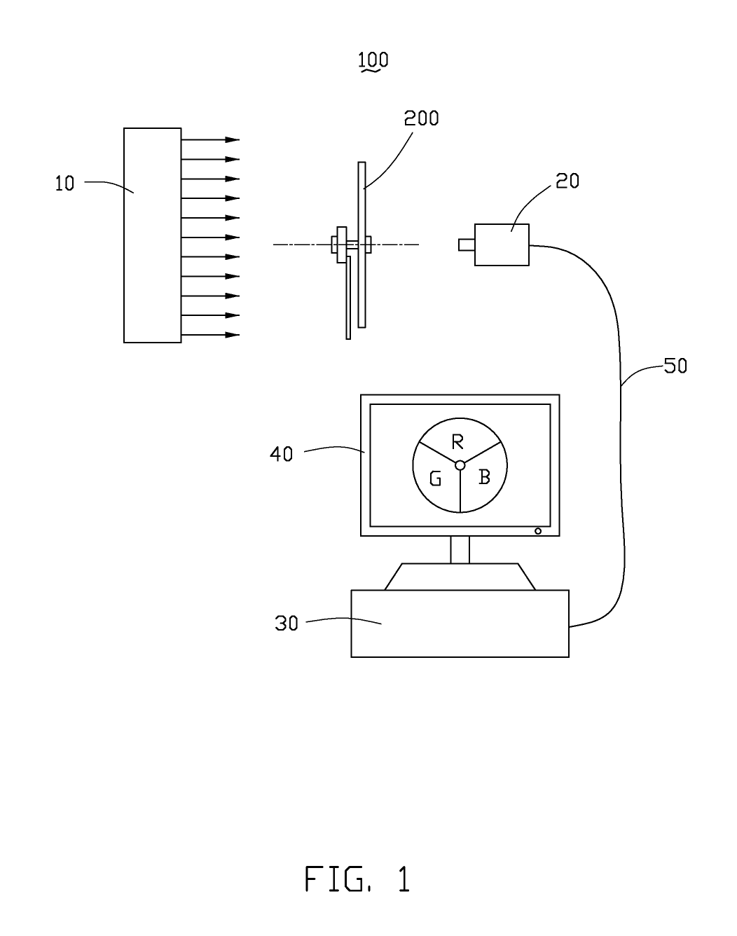

Referring to FIG. 1, a system 100 for checking filter segment arrangement of a color filter 200, in accordance with a present embodiment, includes a light source 10, an image capturing device 20, an processor 30, an output device 40, and a cable 50. The image capturing device 20 is electrically connected to the processor 30 by the cable 50. The output device 40 is electrically connected to the processor 30.

The light source 10 is used for emitting light beams to illuminate the color filter 200 and is located at a side of the color filter 200 which is also illuminated by ambient light. Therefore, the color filter 200 will be seemed like a disk with a plurality of color sectors.

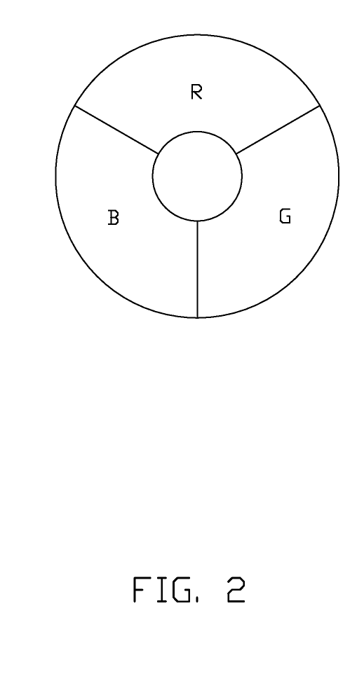

The image capturing device 20 is disposed at a side of the color filter 200 opposite to the light source 10. The image capturing device 20 includes an imaging lens system and an image sensor therein for capturing an image of the color filter 200. Referring to FIG. 2, in the present embodiment, the color filter 200 has three filter segments, a red filter segment, a green filter segment, and a blue filter segment.

The processor 30 is used for processing the image of the color filter 200 captured by the image capturing device 20, and detecting a filter segment arrangement of the color filter 200. The processor 30 can also judge whether the filter segment arrangement of the color filter 200 is identical to a predetermined standard filter segment arrangement. The predetermined standard filter segment arrangement can be stored in the processor 30. In order to detect the filter segment arrangement of the color filter 200, the processor comprises includes a first module for extracting a set of contours from the image of the color filter 200; a second module for detecting colors of points along the circumference of a circle which is wholly formed within the circumference of the image of the color filter 200; and a third module for obtaining the filter segment arrangement according to the arrangement of the colors of the points along the circle. In the present embodiment, the processor is a computer.

The output device 40 is used for outputting the result as judged by the processor. The output device 40 can be a monitor, a loudspeaker and so on. In the present embodiment, the output device 40 is a monitor.

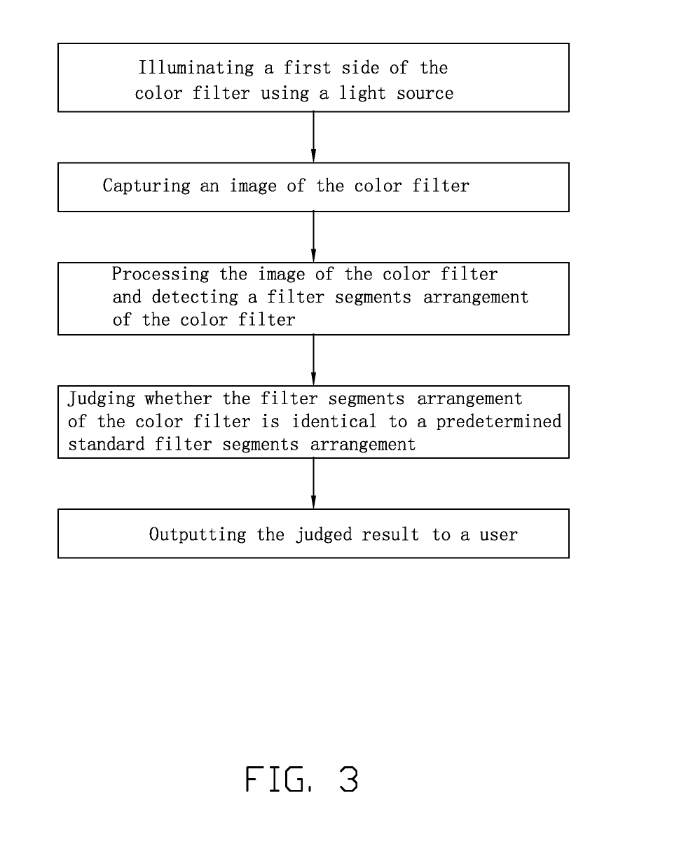

Referring to FIG. 3, a method for checking filter segment arrangement of a color filter 200 is also provided. The method includes the steps of: illuminating a first side of the color filter 200 using a light source 10; capturing an image of a second side of the color filter 200 opposite to the light source 10; processing the image of the color filter 200 and detecting a filter segment arrangement of the color filter 200; judging whether the filter segment arrangement of the color filter 200 is identical to a predetermined standard filter segment arrangement; and outputting the judged result to a user.

The method of detecting the filter segment arrangement of the color filter 200 includes: extracting a set of contours from the image of the color filter 200 by edge detection method; detecting colors of points along the circumference of a circle which is wholly formed within the circumference of the image of the color filter 200; and obtaining the filter segment arrangement according to the arrangement of the colors of the points along the circle.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A system for checking filter segment arrangement of a color filter comprising:
a light source disposed at a first side of a color filter for emitting light beams to illuminate the color filter;
an image capturing device disposed at a second side of the color filter opposite to the light source for capturing an image of the color filter illuminated by the light source;
a processor for processing the image of the color filter captured by the image capturing device, detecting a filter segment arrangement of the color filter and judging whether the filter segment arrangement of the color filter is identical to a predetermined standard filter segment arrangement; and
an output device for outputting the result as judged by the processor.

2. The system as claimed in claim 1, wherein the processor comprises a first module for extracting a set of contours from the image of the color filter; a second module for detecting colors of points along the circumference of a circle which is wholly formed within the circumference of the image of the color filter; and a third module for obtaining the filter segment arrangement according to the arrangement of the colors of the points along the circle.

3. The system as claimed in claim 1, wherein the output device includes a monitor.

4. The color wheel as claimed in claim 1, wherein the output device includes a loudspeaker.

5. A method for checking filter segment arrangement of a color filter comprising:
illuminating a first side of the color filter using a light source;
capturing an image of a second side of the color filter opposite to the light source;
processing the image of the color filter and detecting a filter segment arrangement of the color filter;
judging whether the filter segment arrangement of the color filter is identical to a predetermined standard filter segment arrangement; and
outputting the judged result to a user.

6. The method as claimed in claim 1, wherein the step of detecting the filter segment arrangement of the color filter includes: extracting a set of contours from the image of the color filter by edge detection method; detecting colors of points along the circumference of a circle which is wholly formed within the circumference of the image of the color filter; and obtaining the filter segment arrangement according to the arrangement of the colors of the points along the circle.
